(19) United States
(12) Patent Application Publication
(10) Pub. No.: US 2013/0033051 A1
(43) Pub. Date: Feb. 7, 2013

(54) LOCKING MECHANISM

(71) Applicant: XIAN-DONG GUO, Shenzhen City (CN)

(72) Inventor: XIAN-DONG GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/309,616

(22) Filed: Dec. 2, 2011

(30) Foreign Application Priority Data
Aug. 3, 2011 (CN) 201110221063.6

(51) Int. Cl. B66C 1/00

(52) U.S. Cl. 294/115

(57) ABSTRACT

A locking mechanism for engaging with a threaded rod, the locking mechanism comprises a locking member defining a locking hole axially and a plurality of mounting grooves arranged along a periphery of the locking member, the mounting grooves communicating with the locking hole, and at least three connection lines of each of the mounting grooves defining a rectangular triangle or an acute triangle; a plurality of threaded assemblies, wherein each of the threaded assemblies is rotatably received in each of the mounting grooves, each of the threaded assemblies is substantially perpendicular to a radial direction of the locking hole, and the threaded assemblies are adapted to engage or release a threaded rod; and a sleeve member slidably sleeved on the locking member, the sleeve member moves along the locking member to drive the threaded assemblies to rotate inwardly, or to rotate outwardly to engages or disengage with the threaded rod.

### BACKGROUND

1. Technical Field

The present disclosure relates to locking mechanisms, and more particularly, to a locking mechanism for clamping materials.

2. Description of Related Art

In industrial fields, materials are generally clamped and positioned for machining. A gripper is employed to clamp the materials and then the gripper is sleeved on a positioning rod. A locking mechanism is employed to engage with the positioning rod to clamp the gripper, thus the materials are positioned to be machined. When the materials run out, the locking mechanism is detached from the positioning rod, and the gripper is released to load materials. Generally, the positioning rod is a bolt, and the locking mechanism is a nut. It may take a long time for the locking mechanism to reach a predetermined position for positioning the gripper. The locking mechanism may need to be rotated many circles to detach from the bolt, and to release the gripper. Thus, assembling and/or disassembling the locking mechanism in assembling may be difficult.

Therefore, an improved locking mechanism may be desired.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a locking mechanism, the locking mechanism comprising a threaded member.

FIG. 2 is an exploded, isometric view of the locking mechanism of FIG. 1.

FIG. 3 is similar to FIG. 2, but viewed from another aspect.

FIG. 4 is a cross-section of the locking mechanism of FIG. 1, taken along line IV-IV.

FIG. 5 is a schematic view of the threaded member of FIG. 1 in a state of releasing a threaded rod.

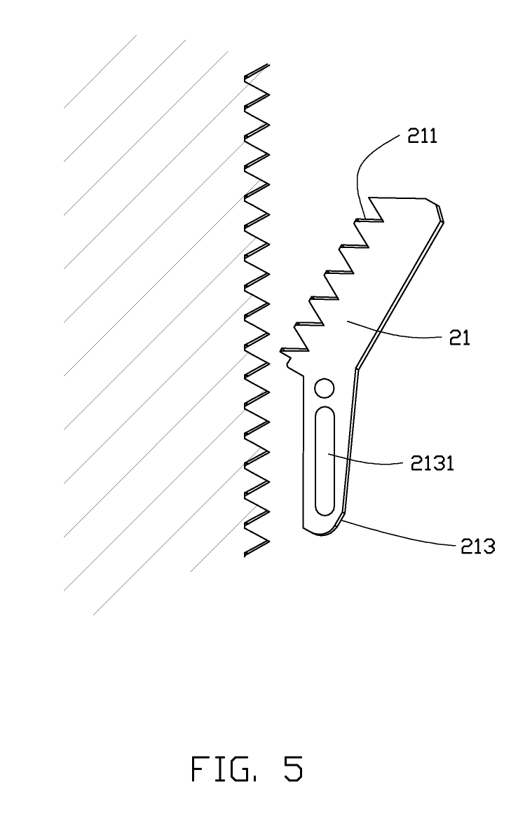

### DETAILED DESCRIPTION

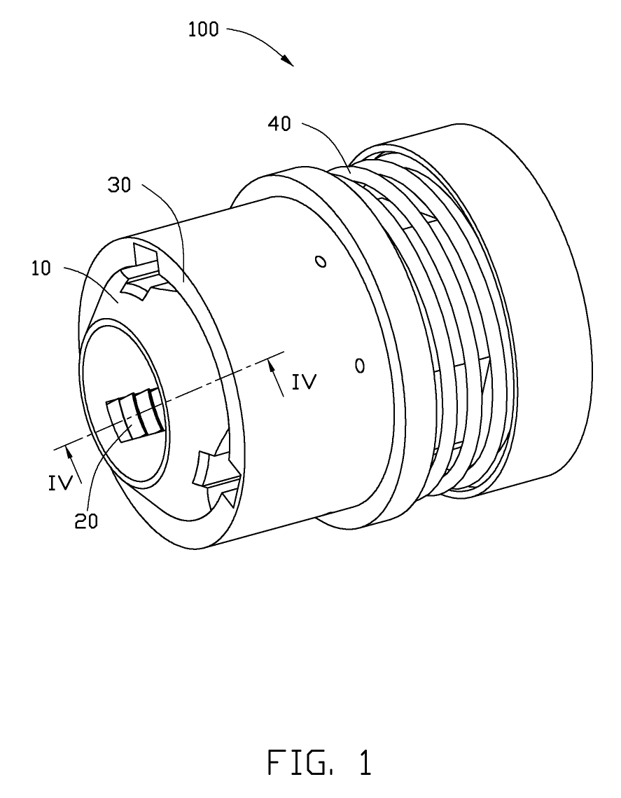

Referring to FIG. 1, an embodiment of a locking mechanism 100 for engaging with a threaded rod to clamp materials, comprises a locking member 10, three threaded assemblies 20, a sleeve member 30, and a resilient member 40. The three threaded assemblies 20 are arranged along a periphery of the locking member 10. The sleeve member 30 is sleeved on the locking member 10, and the resilient member 40 is sleeved on the locking member 10 to enable the sleeve member 30 to slide along the locking member 10 automatically when in need.

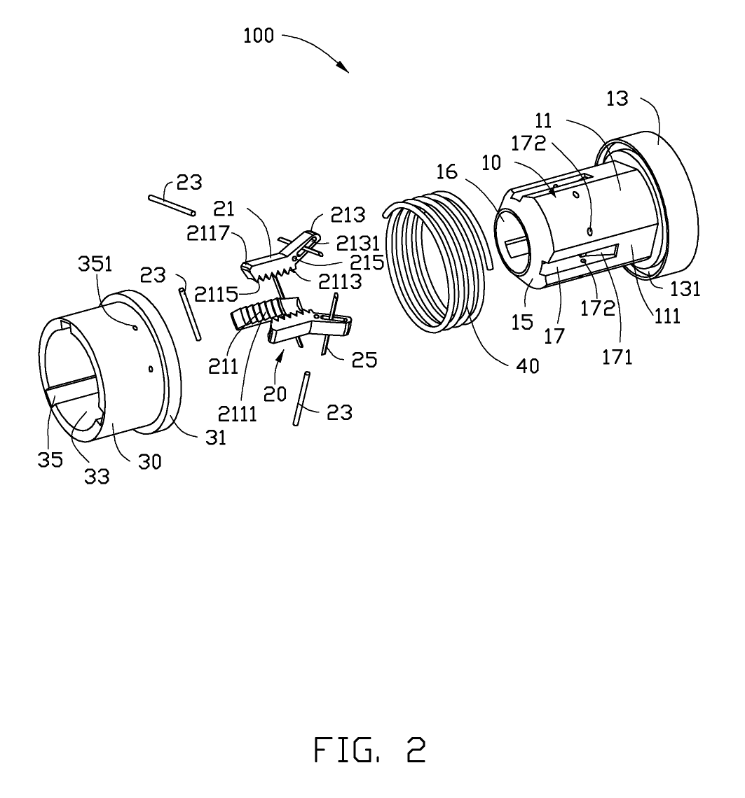

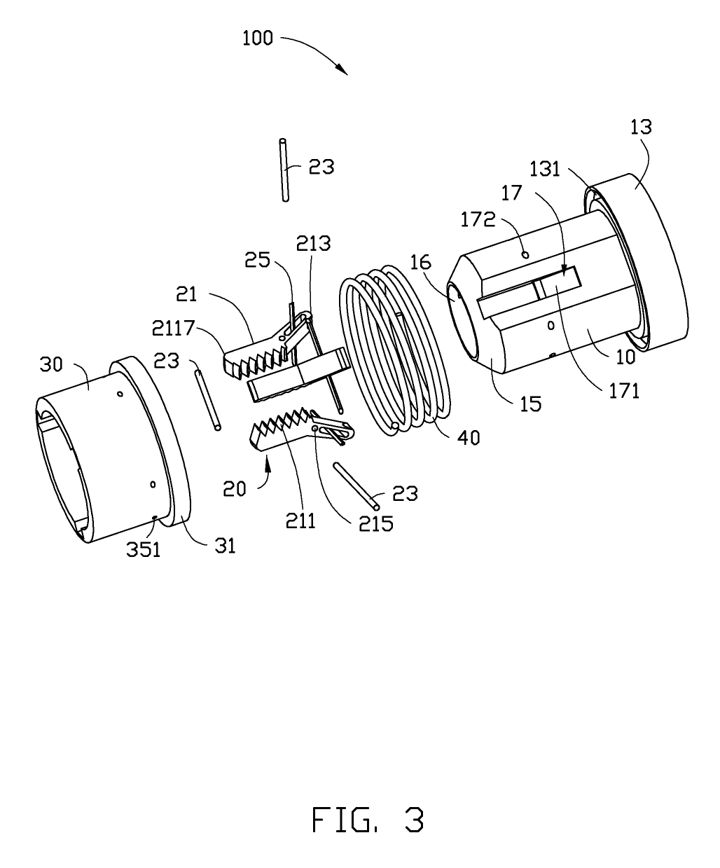

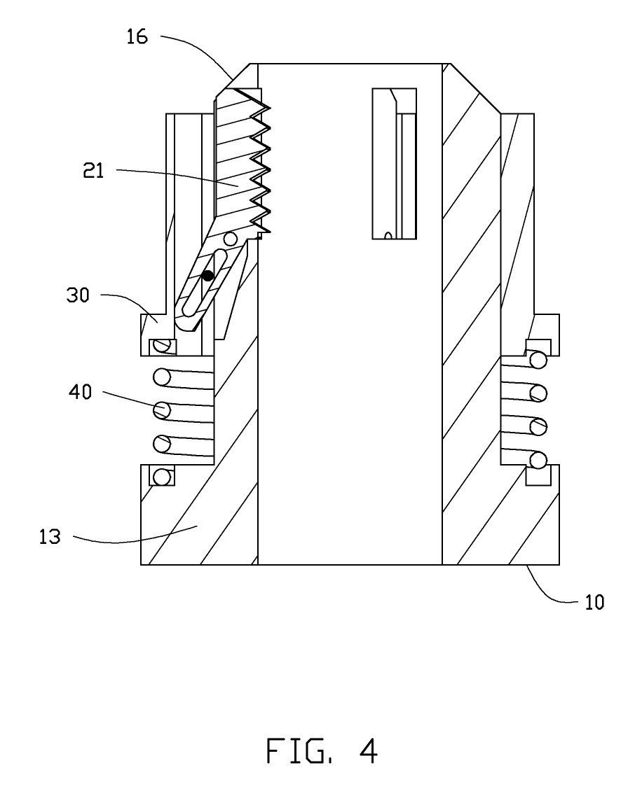

Also referring to FIGS. 2 through 4, the locking member 10 is a substantially cylindrical housing, and comprises a main body 11, a resisting portion 13 coaxially connected to a first end of the main body 11 and a guiding portion 15 coaxially connected to a second end of the main body 11 opposite to a first end. The locking member 10 defines a locking hole 16 extending through the resisting portion 13, the main body 11 and a guiding portion 15. The locking member 10 forms three plane surfaces 111 on a circumferential wall of the main body 11 and each of the three plane surfaces 111 defines a mounting groove 17.

The three plane surfaces 111 are spaced from each other and are parallel to an axis of the main body 11. An external diameter of the resisting portion 13 is greater than that of the main body 11. The resisting portion 13 defines an annular resisting groove 131 on an end surface facing the main body 11. The guiding portion 15 has a cone shape, and outer diameters of the guiding portion increase along an axis of the guiding portion 15 toward the resisting portion 13. The locking hole 16 is a circular hole. Each of the mounting grooves 17 is uniformly spaced from each other. Each of the mounting grooves 17 is arranged along the axis of the main body 11, and communicates with the locking hole 16. A first end of the mounting groove 17 extends to the guiding portion 15, a second end of the mounting groove 17, opposite to the first end, extends to a middle position of the main body 11. Each of the mounting grooves 17 comprises a wedge surface 171. A distance between the wedge surface 171 and each of the three plane surfaces 111 decreases toward the resisting portion 13. Opposite side surfaces of the mounting groove 17 respectively defines two mounting holes 172 adjacent to the resisting portion 13. The two mounting holes 172 are symmetrically and extend though outer surfaces of a circumferential wall of the main body 11. In the embodiment, the first guiding portion 15 is chamfered from an end of the main body 11; the mounting groove 17 is in a substantially rectangular shape.

Each of the three threaded assemblies 20 is received in each of the mounting groove 17. Each of the three threaded assemblies 20 comprises a threaded member 21, a first pivotal member 23 and a second pivotal member 25. Each threaded member 21 is in a strip shape and is placed in one of the mounting groove 17 along the axis of the main body 11. The first pivotal member 23 and the second pivotal member 25 are mounted on the threaded member 23 and parallel to each other. The second pivotal member 25 is capable of driving the threaded member 21 to rotate around the first pivotal member 23.

The threaded member 21 comprises a threaded portion 211 and a pushing portion 213 connected to the threaded portion 211. The threaded portion 211 and the pushing portion 213 cooperatively define an obtuse angle. The threaded member 21 defines a pivotal hole 215 on the pushing portion 213, adjacent to the threaded portion 211. The pivotal hole 215 corresponds to the first pivotal member 23. The threaded portion 211 comprises a plurality of engaging teeth 2111, a latching end 2113, and a locking end 2115. The locking end 2115 and the latching end 2113 are at opposite ends of the plurality of engaging teeth 2111. The plurality of engaging teeth 2111 are arranged along a length of the threaded portion 211, and are parallel to each other. The latching end 2113 is adjacent to the pivotal hole 215. The locking end 2115 forms a guiding surface 2117 deviates from the engaging teeth 2111. The pushing portion 213 defines a pushing hole 2131. The pushing hole 2131 extends two ends of the pushing portion 213 and communicates with outside at the two sides. The first pivotal member 23 is mounted in the pivotal hole 215, and each end of the first pivotal member 23 extends into each of the two mounting holes 172 to enable the threaded member 21 to be rotatably mounted in the mounting groove 17. The second pivotal member 25 is movably mounted in the pushing hole 2131 and opposite ends of the second pivotal member 25 extend into the sleeve member 30. In the embodiment, the guiding surface 2117 is chamfered from an end of a spine shaped threaded portion 211.

The sleeve member 30 is a substantially cylindrical housing sleeved on the main body 11 and shields the mounting grooves 17. The sleeve member 30 comprises an annular abutting portion 31 at an end corresponding to the resisting portion 13 of the locking member 10. The sleeve member 30 axially defines a receiving hole 33, and three receiving grooves 35 arranged along an inner surface of the receiving hole 33. Each of the three receiving grooves 35 communicates with the receiving hole 33, and extends through opposite end surfaces of the sleeve member 30. The sleeve member 30 further defines two connecting holes 351 on two side surfaces of each of the three receiving grooves 35. The two connecting holes 351 communicate with outside of the sleeve member 30.

The resilient member 40 is sleeved on the main body 11 of the locking member 10, and positioned between the resisting portion 13 and the annular abutting portion 31. An end of the resilient member 40 is received in the annular resisting groove 131. In the embodiment, the resilient member 40 is a helical compression spring.

In assembling of the locking mechanism 100, the resilient member 40 is sleeved on the main body 11 with one end received in the resisting groove 131. An external force is applied to compress the resilient member 40. The threaded member 21 is received in the mounting groove 17. The pivotal hole 215 of the threaded member 21 is aligned to each of the two mounting holes 172. The first pivotal member 23 extends into the pivotal hole 215 and each of the two mounting holes 172 such that the threaded member 21 is rotatably received in the mounting groove 17. The sleeve member 30 is then sleeved on the main body 11 with each of the three receiving grooves 35 communicating with each of the mounting grooves 17, and the resilient member 40 is released. Another external force is applied to enable the sleeve member 30 to slide along the locking member 10 and resist the resilient member 40 with the annular abutting portion 31, until each of the two connecting holes 351 communicates with the pushing hole 2131. The second pivotal member 25 extends into each of the two connecting holes 351 and the pushing hole 2131 to rotatably connect the threaded member 21 to the sleeve member 30, releasing the sleeve member 30, thus the locking mechanism 100 is assembled.

To clamp a gripper on a threaded rod, a force is applied to enable the sleeve member 30 to slide along the locking member 10 toward the resisting portion 13. The abutting portion 31 resists the resilient member 40 and the sleeve member 30 drives the second pivotal member 25 to slide in the pushing hole 2131. The second pivotal member 25 drives the threaded member 21 to rotate around the first pivotal member 23 when the second pivotal member 25 slides to a predetermined position in the pushing hole 2131. The threaded potion 211 is outwardly moved away from a periphery of the locking hole 16. The locking mechanism 100 is directly sleeved on a threaded rod at a predetermined position with the guiding portion 15 facing a gripper. The sleeve member 30 is released to slide along the locking member 10, which is resisted by the resilient member 40. The sleeve member 30 drives the threaded member 21 to rotate until the threaded portion 211 is parallel to the axis of the locking hole 16. The threaded portion 211 engages with the threaded rod via the plurality of engaging teeth 2111, thus a pre-positioning of the gripper is achieved, and the outer surface of the guiding portion 15 is parallel to the guiding surface 2117 of the threaded member 21. The locking mechanism 100 is rotated around the threaded rod with the threaded portion 211 engaged with the threaded rod. The locking mechanism 100 is moved toward the gripper along the threaded rod and then positions the gripper on the threaded rod, thus a positioning process of the locking mechanism 100 is achieved. When releasing the gripper, the threaded portion 211 of the threaded member 21 detaches from the threaded rod and the locking mechanism 100 is pulled up directly from the threaded rod.

The threaded members 21 are capable of being rotated and outwardly moved away from the locking hole 16, thus the locking mechanism 100 is directly sleeved on a threaded rod at a predetermined position to enable the locking mechanism 100 to clamp a gripper or materials quickly. When released, the threaded members 21 are rotated and outwardly moved away from the locking hole 16, and the locking mechanism 100 can be pulled out directly. Thus, the locking mechanism 100 saves time. As the outer surface of the guiding portion 15 is parallel to the guiding surface 2117 of the threaded member 21, if the threaded rod comprises an annular portion, the annular portion of the threaded rod may be sleeved on the locking member 10 directly via the guiding portion 15 and the guiding surface 2117. The annular portion of the threaded rod may prevent the threaded member 21 from rotating outwardly when the sleeve member 30 accidentally slides toward the resisting portion 13, thus the locking mechanism 100 cannot be detached from the threaded rod by accident.

In one embodiment, the locking mechanism 100 may comprise a plurality of threaded assemblies 20 and an equal number of mounting grooves 17. The plurality of threaded assemblies 20 may be arranged around the periphery of the locking member 10. At least three connection lines of the mounting grooves 17 define a rectangular triangle or an acute triangle.

In another embodiment, the locking mechanism 100 may comprise only two threaded assemblies 20 and two mounting grooves 17. The two mounting grooves 17 are arranged symmetrically along the radial direction of the locking hole 16.

In yet another embodiment, the resilient member 40 may be omitted if the sleeve member 30 comprises a first threaded portion on an inner sidewall, and the locking member 10 comprises a second threaded portion at an outer sidewall. The sleeve member 30 is moved along the locking member 10 by the first threaded portion engaging with second threaded portion.

In another embodiments, the threaded member 21 may be rotatably connected to the locking member 10 by other structures, for examples, the threaded member 21 may comprise two posts outwardly extending from opposite sides, and the locking member 10 may define two pivotal grooves on opposite surfaces of the mounting grooves, and each of the two posts may be rotatably received in each of the two pivotal grooves.

Finally, while various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A locking mechanism for engaging with a threaded rod, the locking mechanism comprising:
a locking member defining a locking hole axially and a plurality of mounting grooves arranged along a periphery of the locking member, the plurality of mounting grooves communicating with the locking hole, and at least three connection lines of each of the plurality of mounting grooves defining a rectangular triangle or an acute triangle;
a plurality of threaded assemblies, wherein each of the plurality of threaded assemblies is rotatably received in each of the plurality of mounting grooves, each of the plurality of threaded assemblies is substantially perpendicular to a radial direction of the locking hole, and the plurality of threaded assemblies are adapted to engage or release a threaded rod; and
a sleeve member slidably sleeved on the locking member, the sleeve member is adapted to drive the plurality of threaded assemblies to rotate inwardly, or to rotate outwardly; the sleeve member moves along the locking member and resists a first end or a second end of each of the plurality of the threaded assemblies, and the plurality of threaded assemblies rotate around a middle portion of the sleeve member to engages or disengage with the threaded rod.

2. The locking mechanism of claim 1, wherein the plurality of mounting grooves are parallel to each other, and uniformly spaced from each other.

3. The locking mechanism of claim 1, the sleeve member comprises a first threaded portion on an inner sidewall of the sleeve member; and the locking member comprises a second threaded portion at an outer sidewall of the locking member, wherein the sleeve member moves axially along the locking member with the first threaded portion engaged with the second threaded portion.

4. The locking mechanism of claim 1, wherein the sleeve member defines a receiving hole axially, and a plurality of receiving grooves on an inner surface of the receiving hole;
the plurality of receiving grooves communicate with the receiving hole, and extend through opposite end surfaces of the sleeve member; and each of the plurality of threaded assemblies is partially received in each of the plurality of receiving grooves.

5. The locking mechanism of claim 1, the locking member comprises a main body, a resisting portion coaxially connected to the main body, and a resilient member; the sleeve member comprises an abutting portion, wherein the resilient member is contained between the resisting portion and the abutting portion.

6. The locking mechanism of claim 5, wherein the locking member further comprises a guiding portion opposite to the resisting portion; a first end of the mounting groove extends to the guiding portion; a second end of the mounting groove, opposite to the first end, extends to a middle position of the main body.

7. The locking mechanism of claim 5, wherein an external diameter of the resisting portion is greater than an external diameter of the main body, and the resisting portion defines an annular resisting groove on an end surface facing the main body, an end of the resilient member is received in the annular resisting groove.

8. The locking mechanism of claim 1, wherein each of the plurality of threaded assemblies comprises a threaded member, a first pivotal member, and a second pivotal member; the threaded member is received in each of the mounting groove; the first pivotal member and the second pivotal member are mounted on the threaded member, and are parallel to each other; the threaded member is driven by the second pivotal member to rotate around the first pivotal member.

9. The locking mechanism of claim 8, wherein the threaded member comprises a threaded portion, a pushing portion opposite to the threaded portion; the threaded member defines a pivotal hole on the pushing portion, adjacent to the threaded portion; the threaded portion and the pushing portion cooperatively define an obtuse angle; opposite side surfaces of the mounting groove respectively define a mounting hole, the first pivotal member is mounted in the pivotal hole, and each end of the first pivotal member extends into each of the two mounting holes, and each threaded member is rotatably mounted in each of the plurality of mounting grooves through the first pivotal member.

10. The locking mechanism of claim 9, wherein the sleeve member defines a connecting hole, the pushing portion defines a pushing hole extending through opposite side surfaces of the pushing portion and communicating with outside; the second pivotal member is movably mounted in the pushing hole, and each end of the second pivotal member extends into each of the two connecting holes.

11. A locking mechanism for engaging with a threaded rod, the locking mechanism comprising:
a locking member defining a locking hole axially, and two mounting grooves arranged symmetrically along a radial direction of the locking hole, each of the two mounting grooves communicating with the locking hole;
two threaded assemblies rotatably, wherein each of the two threaded assemblies is received in each of the two mounting grooves, and each of the two threaded assemblies is perpendicular to the radial direction of the locking hole, and the two threaded assemblies are adapted to engage or release a threaded rod; and
a sleeve member slidably sleeved on the locking member, the sleeve member is adapted to drive the two threaded assemblies to rotate inwardly, or to rotate outwardly; the sleeve member moves along the locking member and resists a first end or a second end of the two threaded assemblies, and the two threaded assemblies rotate around a middle portion of the sleeve member to engages or disengage with the threaded rod.

12. The locking mechanism of claim 11, the sleeve member comprises a first threaded portion on an inner sidewall of the sleeve member; and the locking member comprises a second threaded portion at an outer sidewall of the locking member, wherein the sleeve member moves axially along the locking member with the first threaded portion engaged with the second threaded portion.

13. The locking mechanism of claim 11, wherein the sleeve member defines a receiving hole axially, and two receiving grooves corresponding to the two mounting grooves; each of the two receiving grooves communicates with the receiving hole, and extends through opposite end surfaces of the sleeve member; each of the two threaded assemblies is partially received in each of the two receiving grooves.

14. The locking mechanism of claim 11, the locking member comprises a main body, and a resisting portion coaxially connected to the main body, and a resilient member; the sleeve member comprises an abutting portion, wherein the resilient member is contained between the resisting portion and the abutting portion.

15. The locking mechanism of claim 14, wherein the locking member further comprises a guiding portion opposite to the resisting portion; a first end of the mounting groove extends to the guiding portion; a second end of the mounting groove, opposite to the first end, extends to a middle position of the main body.

16. The locking mechanism of claim 14, wherein an external diameter of the resisting portion is greater than an external diameter of the main body, and the resisting portion defines an annular resisting groove on an end surface facing the main body, an end of the resilient member is received in the annular resisting groove.

17. The locking mechanism of claim 11, wherein each of the two threaded assemblies comprises a threaded member, a first pivotal member, and a second pivotal member; the threaded member is received in one of the two mounting grooves; the first pivotal member and the second pivotal member are mounted on the threaded member, and are parallel to each other; the threaded member is driven by the second pivotal member to rotate around the first pivotal member.

18. The locking mechanism of claim 17, wherein the threaded member comprises a threaded portion, a pushing portion opposite to the threaded portion; the threaded member defines a pivotal hole on the pushing portion, adjacent to the threaded portion; the threaded portion and the pushing portion cooperatively define an obtuse angle; opposite side surfaces of the mounting groove respectively define a mounting hole, the first pivotal member is mounted in the pivotal hole, and each end of the first pivotal member extends into each of the two mounting holes, and each threaded member is rotatably mounted in each of the two mounting grooves through the first pivotal member.

19. The locking mechanism of claim 18, wherein the sleeve member defines two connecting holes, the pushing portion defines a pushing hole extending through opposite side surfaces of the pushing portion and communicating with outside; the second pivotal member is movably mounted in the pushing hole, and each end of the second pivotal member extends into each of the two connecting holes.
